(19) United States
(12) Patent Application Publication
(10) Pub. No.: US 2026/0168459 A1
(43) Pub. Date: Jun. 18, 2026

(54) INTERNAL COMBUSTION ENGINE

(71) Applicant: ISUZU MOTORS LIMITED, Yokohama-shi (JP)

(72) Inventor: Akira SERIZAWA, Fujisawa-shi (JP)

(21) Appl. No.: 19/361,054

(22) Filed: Oct. 17, 2025

(30) Foreign Application Priority Data
Dec. 18, 2024 (JP) 2024-221750

(51) Int. Cl. F02F 3/26

(52) U.S. Cl. CPC F02F 3/26

(57) ABSTRACT

A cavity of an internal combustion engine includes: a raised portion having a first inclined surface inclined downward from the radial center toward the radially outer side; a protrusion provided on the outer side of the raised portion; and a connecting portion that connects the protrusion and the raised portion. The connecting portion includes a second inclined surface continuous with a curved surface, the second inclined surface being lower toward the radially outer side; and a step portion formed between the second inclined surface and the raised portion. An angle of the second inclined surface with respect to an orthogonal plane perpendicular to the axial direction of the piston is greater than an angle of the first inclined surface with respect to the orthogonal plane.

### CROSS-REFERENCE TO RELATED APPLICATIONS

The present application claims priority to Japanese Patent Application number 2024-221750, filed on December 18, 2024 contents of which are incorporated herein by reference in their entirety.

### BACKGROUND OF THE INVENTION

The present disclosure relates to an internal combustion engine having a piston in which a cavity is formed. In order to mix fuel (unburned fuel) and air, the cavity of a piston disclosed in Japanese Unexamined Patent Application Publication No. 2021-11843 is provided with a step portion for separating the fuel flowing along the curved portion toward the raised portion at the center.

However, in the above-described technique, the fuel separated from the step portion easily comes into contact with the raised portion before mixing with the surrounding air, resulting in insufficient air intake and reduced fuel–air mixing.

### BRIEF SUMMARY OF THE INVENTION

The present disclosure has been made in view of these points, and its object is to promote the mixing of fuel and air in a cavity.

A first aspect of the present disclosure provides an internal combustion engine including: a piston having a cavity formed in a central portion of a top surface thereof; and an injector that injects fuel into the cavity, wherein the cavity includes: a raised portion having a first inclined surface inclined downward from a radial center of the piston toward an outer side in a radial direction; a protrusion provided along a circumferential direction of the piston on an outer side of the raised portion in the radial direction; and a connecting portion that is provided so as to surround the raised portion and connects the protrusion and the raised portion, the connecting portion includes a curved surface continuous with the protrusion, a second inclined surface that is continuous with the curved surface on an inner side in the radial direction and inclined so as to become lower toward an outer side in the radial direction, and a step portion formed between the second inclined surface and the raised portion, and an angle of the second inclined surface with respect to an orthogonal plane perpendicular to an axial direction of the piston is greater than an angle of the first inclined surface with respect to the orthogonal plane.

### BRIEF DESCRIPTION OF THE DRAWINGS

FIG. 1 is a schematic view showing a configuration of an internal combustion engine 1 according to one embodiment.

FIG. 2 is a schematic view showing a cross-sectional configuration of a cavity 40.

FIG. 3 is a schematic view showing a state in which an injector 22 has sprayed fuel onto a protrusion 45.

FIG. 4 is a schematic view showing a state in which the fuel flows along a second inclined surface 54.

FIG. 5 is a schematic view showing a state in which the fuel is separated from the tip of the second inclined surface 54.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Configuration of an internal combustion engine

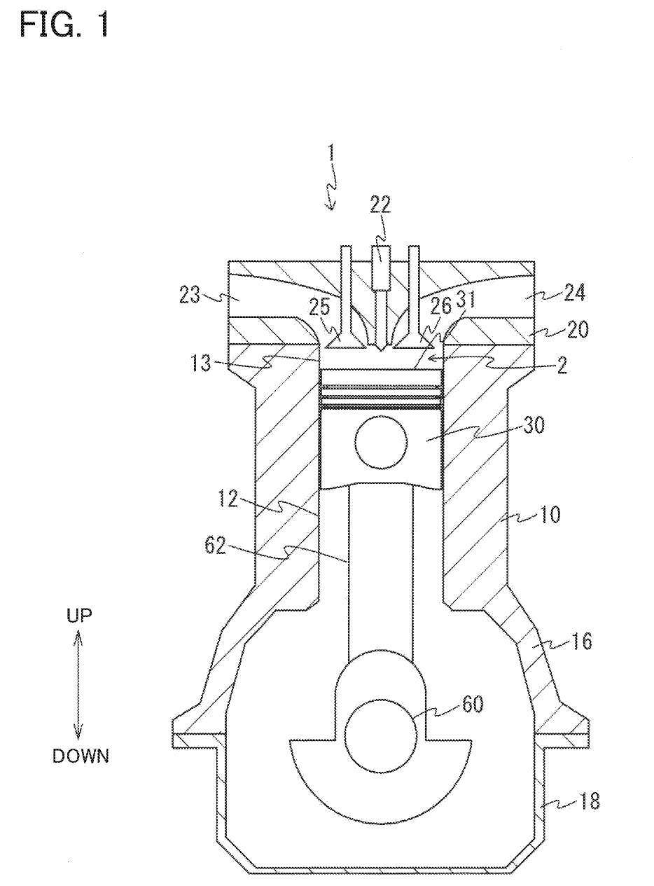

FIG. 1 is a schematic view showing a configuration of an internal combustion engine 1 according to one embodiment. Here, the internal combustion engine 1 is mounted on a vehicle such as a truck, but is not limited thereto, and may be mounted on, for example, a ship.

The internal combustion engine 1 is, for example, a diesel engine. The internal combustion engine 1 is a power source that generates power for causing a vehicle to travel by burning and expanding an air-fuel mixture of intake air and fuel in a combustion chamber 2. The internal combustion engine 1 includes a cylinder block 10, a cylinder head 20, a piston 30, and a crankshaft 60.

The cylinder block 10 includes a cylinder 12 that houses the piston 30 in a manner allowing the piston 30 to reciprocate, and a crankcase 16 that houses the crankshaft 60. An oil pan 18 that reserves lubricating oil is attached to the crankcase 16.

The cylinder head 20 is provided to an upper portion of the cylinder block 10. The cylinder head 20 includes an injector 22, an intake valve 25, and an exhaust valve 26. The injector 22 injects fuel into the combustion chamber 2 defined by a top surface of the piston 30, an inner wall surface 13 of the cylinder 12, and the cylinder head 20. The intake valve 25 opens and closes to introduce intake air (air) from an intake port 23 into the combustion chamber 2. The exhaust valve 26 opens and closes to guide the exhaust gas from the combustion chamber 2 into the exhaust port 24.

The piston 30 reciprocates within the cylinder 12. When the piston 30 reciprocates between a top dead center and a bottom dead center, the piston 30 slides on the inner wall surface 13 of the cylinder 12. The lubricating oil is supplied to the inner wall surface 13 to form an oil film. Since the oil film is formed on the inner wall surface 13, frictional force when the piston 30 slides on the inner wall surface 13 can be reduced.

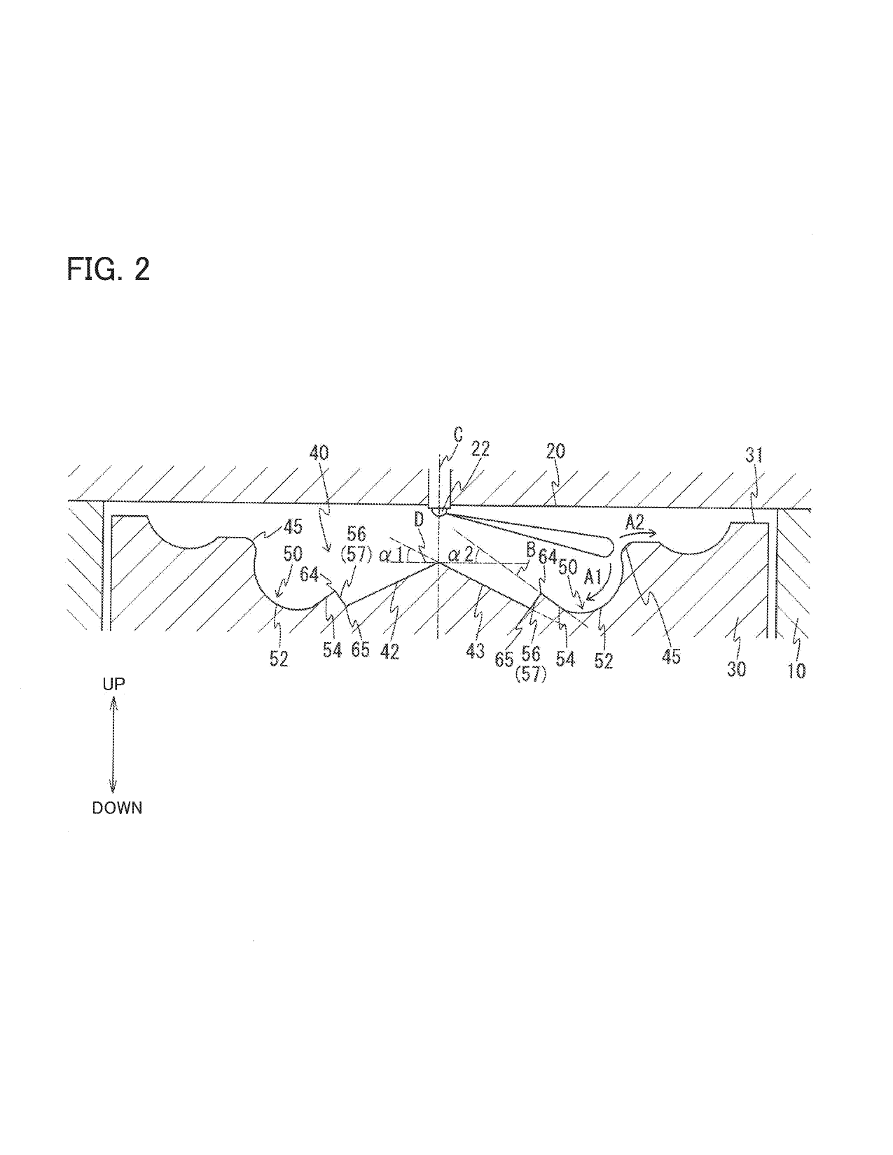

A top surface 31 of the piston 30 is provided with a cavity 40 (see FIG. 2). The cavity 40 is formed by recessing the top surface 31, and constitutes a part of the combustion chamber 2. For example, when the piston 30 is near the top dead center, the injector 22 injects fuel into the cavity 40. The fuel injected into the cavity 40 is mixed with air within the cavity 40 and combusts. A detailed configuration of the piston 30 will be described later.

The crankshaft 60 is coupled to the piston 30 via a connecting rod (hereinafter referred to as “con rod”) 62. The crankshaft 60 converts reciprocating motion of the piston 30 into rotational motion.

### Detailed configuration of the cavity

FIG. 2 is a schematic view showing a cross-sectional configuration of the cavity 40. The vertical direction shown in FIG. 2 is parallel to the axial direction of the piston 30. Furthermore, the vertical direction is parallel to the up-down direction. FIG. 2 shows the piston 30 positioned near the top dead center.

The cavity 40 is formed by recessing the central portion of the top surface 31 of the piston 30. As shown in FIG. 2, the cavity 40 includes a raised portion 42, a protrusion 45, and a connecting portion 50.

The raised portion 42 is a portion raised from the bottom portion of the cavity 40 toward the injector 22. As one example, the raised portion 42 is raised in a conical shape. The raised portion 42 is provided at the radially central portion of the piston 30. The raised portion 42 faces the injector 22 when the piston 30 is at the top dead center. The apex of the raised portion 42 and the injector 22 are positioned on the central axis C of the piston 30.

The raised portion 42 has a first inclined surface 43. The first inclined surface 43 is inclined downward in the vertical direction from the apex (the radial center of the piston 30) of the raised portion 42 toward the radially outer side. The first inclined surface 43 is, for example, a flat surface inclined at a predetermined angle. Here, as shown in FIG. 2, the angle of the first inclined surface 43 with respect to an orthogonal plane D, which is perpendicular to the axial direction of the piston 30, is assumed to be angle α1.

The protrusion 45 protrudes upward in the vertical direction at a position outside the raised portion 42 in the radial direction of the piston 30. The protrusion 45 is located closer to the top surface 31 of the piston 30 than the raised portion 42 in the cavity 40. Specifically, the protrusion 45 is located vertically above the apex of the raised portion 42. It should be noted that the vertical relationship between the protrusion 45 and the raised portion 42 can be appropriately varied depending on specifications required of the internal combustion engine 1. The protrusion 45 is provided along the circumferential direction of the piston 30. Here, the protrusion 45 is continuously provided over the entire circumference so as to surround the raised portion 42 in the circumferential direction.

As shown in FIG. 2, the injector 22 sprays fuel toward the protrusion 45. The injector 22 has a plurality of injection holes provided at predetermined intervals in the circumferential direction, and each injection hole sprays fuel. In FIG. 2, for convenience of explanation, only the fuel injection direction by one injection hole is shown. The fuel injected by the injector 22 (specifically, the fuel spray) is diverted by the protrusion 45. Some of the diverted fuel flows toward the connecting portion 50, as indicated by the arrow A1 in FIG. 2, while the remaining fuel flows outward in the radial direction of the cavity 40, as indicated by the arrow A2.

The connecting portion 50 is located between the raised portion 42 and the protrusion 45 in the radial direction of the piston 30, and connects the protrusion 45 and the raised portion 42. The connecting portion 50 is located vertically below the protrusion 45. The connecting portion 50 is provided at a position corresponding to the protrusion 45 in the circumferential direction. The protrusion 45 is provided so as to surround the raised portion 42 in the circumferential direction, and the connecting portion 50 is also provided so as to surround the raised portion 42. Here, the connecting portion 50 is provided along the circumferential direction of the piston 30. Some of the fuel (unburned fuel) diverted from the protrusion 45 flows along the connecting portion 50 toward the center of the cavity 40.

As shown in FIG. 2, the connecting portion 50 has a curved surface 52, a second inclined surface 54, and a step portion 56. The curved surface 52 is a portion of the connecting portion 50 located on the radially outer side of the piston 30, and is continuous with the protrusion 45. The curved surface 52 serves as a guide surface, guiding the fuel diverted by the protrusion 45 toward the center of the cavity 40. Here, the curved surface 52 is curved with a predetermined curvature to facilitate guiding the fuel toward the center of the cavity 40.

The curved surface 52 is provided along the circumferential direction. The curved surface 52 is formed continuously over the entire circumference in the circumferential direction so as to surround the raised portion 42. Accordingly, even if the fuel diverted by the protrusion 45 spreads in the circumferential direction, it can flow more easily along the curved surface 52, thereby facilitating its guidance toward the center of the cavity 40.

The second inclined surface 54 is located on the inner side (central side) of the curved surface 52 in the radial direction of the piston 30. Specifically, the second inclined surface 54 is located between the curved surface 52 and the step portion 56 in the radial direction of the piston 30. One end of the second inclined surface 54 is continuous with the curved surface 52, and the other end of the second inclined surface 54 is continuous with the step portion 56. Similarly to the curved surface 52, the second inclined surface 54 is provided along the circumferential direction. Similar to the curved surface 52, the second inclined surface 54 is provided continuously over the entire circumference in the circumferential direction. Continuing from the curved surface 52, the second inclined surface 54 guides the fuel toward the center of the cavity 40.

The second inclined surface 54 is inclined toward the injector 22. Specifically, the second inclined surface 54 is inclined so that a connecting portion (one end of the second inclined surface 54) with the curved surface 52 is located below a connecting portion (the other end of the second inclined surface 54) with the step portion 56 in the vertical direction. The second inclined surface 54 is inclined between the curved surface 52 and the step portion 56, so as to become lower toward the radially outer side. The second inclined surface 54 is a flat surface inclined at a predetermined angle α2 with respect to the orthogonal plane D, which is perpendicular to the axial direction of the piston 30. Since the second inclined surface 54 is inclined in this way, the fuel flowing along the second inclined surface 54 can proceed straight toward the radially central portion and upward in the vertical direction.

The angle α2 of the second inclined surface 54 with respect to the orthogonal plane D is greater than the angle α1 of the first inclined surface 43 with respect to the orthogonal plane D. That is, the second inclined surface 54 is a surface steeper than the first inclined surface 43. Accordingly, the fuel separated from the second inclined surface 54 can more easily draw in the air around the first inclined surface 43, being separated from the first inclined surface 43. As a result, mixing of fuel and air is promoted.

The step portion 56 is a portion that forms a step between the raised portion 42 and the connecting portion 50. The step portion 56 is formed between the raised portion 42 and the second inclined surface 54. Specifically, the step portion 56 is formed between the first inclined surface 43 and the second inclined surface 54 of the raised portion 42. The step portion 56 is provided along the circumferential direction. The step portion 56 is provided continuously over the entire circumference in the circumferential direction. Providing the step portion 56 allows the fuel flowing straight along the second inclined surface 54 to be more easily separated at the step portion 56. In other words, the fuel flowing straight along the second inclined surface 54 can be more easily separated from the surface forming the cavity 40 at the step portion 56.

The step portion 56 has a step surface 57, an upper end portion 64, and a lower end portion 65. The step surface 57 is a surface inclined with respect to the second inclined surface 54. The upper end portion 64 is a portion that connects the step surface 57 and the second inclined surface 54 at one end (upper end) of the step surface 57. The lower end portion 65 is a portion that connects the step surface 57 and the first inclined surface 43 at the other end (lower end) of the step surface 57. The step surface 57 is, for example, a flat surface perpendicular to the second inclined surface 54. With this configuration, the upper end portion 64 forms a corner, so that the fuel flowing along the second inclined surface 54 is more easily separated from the surface forming the cavity 40 at the upper end portion 64. The fuel flowing along the connecting portion 50 proceeds straight toward the radially central portion and upward in the vertical direction while flowing along the second inclined surface 54. The fuel that has flowed along the second inclined surface 54 proceeds straight without changing its direction even after passing through the upper end portion 64. Therefore, the fuel flowing along the second inclined surface 54 separates from the surface forming the cavity 40 at the upper end portion 64, where the second inclined surface 54 and the step surface 57 are connected, and continues to proceed.

The lower end portion 65 of the step portion 56 connected to the first inclined surface 43 is located below the upper end portion 64 of the step portion 56 connected to the second inclined surface 54 in the vertical direction. In the above description, the step surface 57 is a flat surface, but is not limited thereto, and the step surface 57 may be a curved surface.

The connecting portion, where the second inclined surface 54 and the curved surface 52 are continuous, may be located below the lower end portion 65 that connects the step portion 56 (step surface 57) and the first inclined surface 43 in the vertical direction. In this case, the depth of the raised portion 42 from the top surface 31 of the piston 30 can be reduced, thereby reducing the volume of the space of the cavity 40, which is the recessed portion. As a result, the compression ratio during the compression stroke of the internal combustion engine 1 can be increased.

The second inclined surface 54 is provided such that an imaginary line B, extending from the second inclined surface 54 shown in FIG. 2, passes above the apex of the raised portion 42. The imaginary line B is an imaginary line extending from the second inclined surface 54 toward the radially inner side (central side) of the piston 30 along the surface of the second inclined surface 54. Specifically, the imaginary line B extending from the second inclined surface 54 passes between the apex of the raised portion 42 and the injector 22. Accordingly, the separated fuel can flow away more easily from the first inclined surface 43 of the raised portion 42, allowing the fuel to draw in air around the first inclined surface 43, and thereby promoting the mixing of fuel and air. It should be noted that the imaginary line B extending from the second inclined surface 54 may pass through the injector 22 when the piston 30 is at the top dead center.

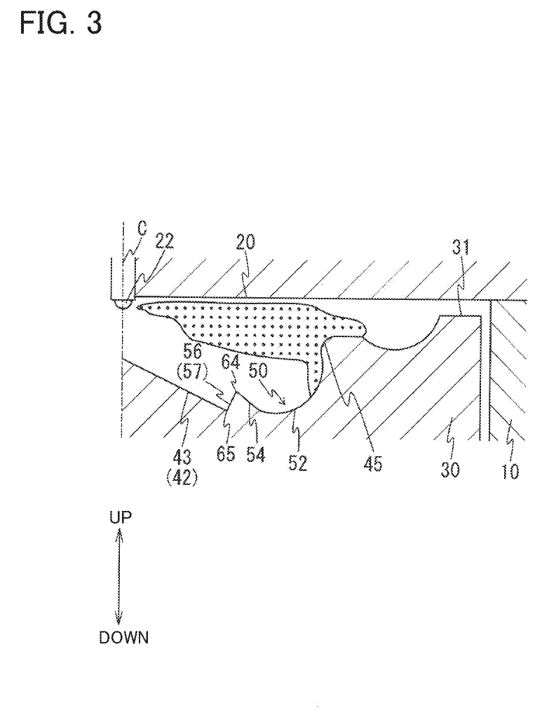

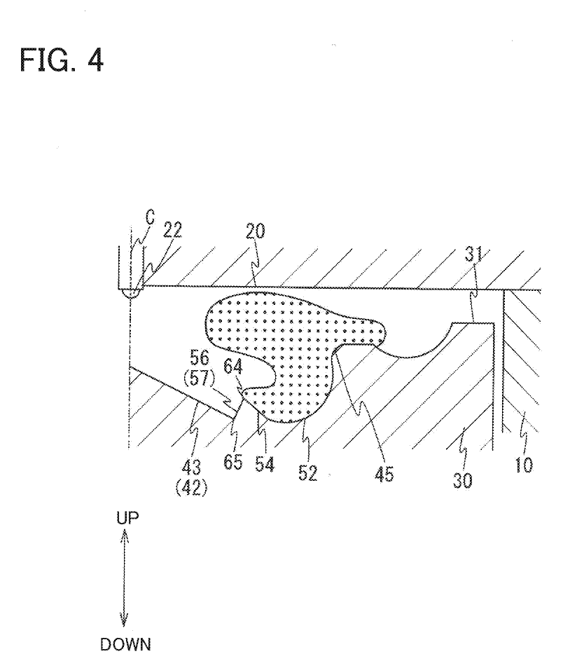

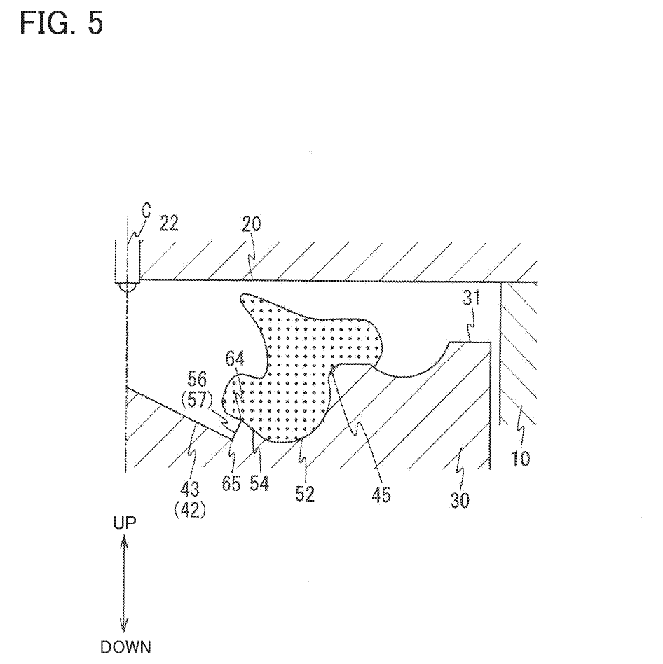

Here, the flow of the fuel injected by the injector 22 in the cavity 40 will be described with reference to FIGS. 3 to 5. FIG. 3 is a schematic view showing the state immediately after the injector 22 has sprayed fuel onto the protrusion 45. FIG. 4 is a schematic view showing the state in which the fuel flows along the second inclined surface 54. FIG. 5 is a schematic view showing the state in which the fuel is separated from the surface forming the cavity 40 at the upper end portion 64. FIG. 3 shows the piston 30 positioned near the top dead center, and FIGS. 4 and 5 show the state in which the piston 30 is moving toward the bottom dead center.

Here, it is assumed that the injector 22 has sprayed fuel when the piston 30 is near the top dead center. As shown in FIG. 3, the injector 22 sprays fuel toward the protrusion 45. The injected fuel impinges on the protrusion 45 and is diverted. Some of the diverted fuel flows over the protrusion 45 toward the outer side in the radial direction, while the remaining fuel flows onto the curved surface 52 of the connecting portion 50.

After the injector 22 has sprayed the fuel, the piston 30 moves toward the bottom dead center. At this time, as shown in FIG. 4, the fuel that has flowed from the protrusion 45 onto the curved surface 52 flows along the second inclined surface 54, in continuation from the curved surface 52. By flowing along the second inclined surface 54, the fuel’s flow direction becomes straight. Specifically, the fuel flows directly along the second inclined surface 54 toward the radially central portion and upward in the vertical direction.

When the piston 30 further moves toward the bottom dead center, as shown in FIG. 5, the fuel flowing along the second inclined surface 54 separates from the surface that forms the cavity 40 at the upper end portion 64 connected to the step surface 57 of the second inclined surface 54. In particular, because the fuel flows directly along the second inclined surface 54, the fuel separates more easily. In contrast to the present embodiment, when the curved surface 52 is connected directly to the step surface 57 without the second inclined surface 54, the fuel’s flow direction is not straight, making it less likely to separate. Further, even if the fuel separates, the fuel’s flow direction is not straight, and therefore the fuel is more likely to come into contact with the raised portion 42.

The separated fuel does not contact the raised portion 42 (specifically, the first inclined surface 43), and flows away from the first inclined surface 43. At this time, the fuel draws in ambient air and combusts. In particular, because a space exists between the flowing fuel and the first inclined surface 43, air is easily drawn into the fuel from this space, thereby promoting fuel combustion.

### Modification

In the above description, the step portion 56 and the second inclined surface 54 are continuously provided around the raised portion 42 along the circumferential direction over the entire circumference. But the present embodiment is not limited thereto. For example, a plurality of step portions 56 and a plurality of second inclined surfaces 54 are provided at predetermined intervals in the circumferential direction. Specifically, the step portion 56 and the second inclined surface 54 are provided in accordance with the positions of the plurality of injection holes of the injector 22 in the circumferential direction. Even in this case, the fuel injected from each injection hole of the injector 22 and flowing along the connecting portion 50 is likely to separate at the upper end portion 64.

In the above description, the second inclined surface 54 is a flat surface, but the configuration is not limited thereto. For example, the second inclined surface 54 may be a curved surface. Similarly, the first inclined surface 43 may also be a curved surface.

### Effects of the Embodiment

The cavity 40 of the piston 30 of the above-described embodiment includes: the raised portion 42 having the first inclined surface 43; the protrusion 45 provided along the circumferential direction of the piston 30 on the outer side of the raised portion 42; and the connecting portion 50 provided so as to surround the raised portion 42 and connecting the protrusion 45 and the raised portion 42. The connecting portion 50 includes: the curved surface 52 continuous with the protrusion 45; the second inclined surface 54 continuous with the curved surface 52 on the radially inner side and inclined so as to become lower toward the radially outer side; and the step portion 56 formed between the second inclined surface 54 and the raised portion 42. The angle α2 of the second inclined surface 54 with respect to the orthogonal plane D, which is perpendicular to the axial direction of the piston 30, is greater than the angle α1 of the first inclined surface 43 with respect to the orthogonal plane D. Providing the above-described second inclined surface 54 allows the fuel that has flowed along the second inclined surface 54 and along the curved surface 52 to be more easily separated at the upper end portion 64 that connects the second inclined surface 54 and the step portion 56. In addition, since the inclination angle α2 of the second inclined surface 54 is greater than the inclination angle α1 of the first inclined surface 43, the separated fuel is less likely to come into contact with the first inclined surface 43, allowing the fuel to draw in the surrounding air. As a result, the mixing of the separated fuel and air is promoted, thereby increasing combustion efficiency.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An internal combustion engine comprising:
a piston having a cavity formed in a central portion of a top surface thereof; and
an injector that injects fuel into the cavity, wherein the cavity includes:
a raised portion having a first inclined surface inclined downward from a radial center of the piston toward an outer side in a radial direction;
a protrusion provided along a circumferential direction of the piston on an outer side of the raised portion in the radial direction; and
a connecting portion that is provided so as to surround the raised portion and connects the protrusion and the raised portion,
the connecting portion includes a curved surface continuous with the protrusion, a second inclined surface that is continuous with the curved surface on an inner side in the radial direction and inclined so as to become lower toward an outer side in the radial direction, and a step portion formed between the second inclined surface and the raised portion, and
an angle of the second inclined surface with respect to an orthogonal plane perpendicular to an axial direction of the piston is greater than an angle of the first inclined surface with respect to the orthogonal plane.

2. The internal combustion engine according to claim 1, wherein the second inclined surface is a flat surface inclined at a predetermined angle with respect to the orthogonal plane.

3. The internal combustion engine according to claim 1, wherein the step portion includes a step surface inclined with respect to the second inclined surface, an upper end portion connecting the step surface and the second inclined surface, and a lower end portion connecting the step surface and the first inclined surface, and
the lower end portion is located below the upper end portion in a vertical direction.

4. The internal combustion engine according to claim 1, wherein a connecting portion between the second inclined surface and the curved surface is located below the lower end portion in the vertical direction.

5. The internal combustion engine according to claim 1, wherein an imaginary line extending from the second inclined surface toward the inner side in the radial direction along a surface of the second inclined surface passes through the injector when the piston is at top dead center.

6. The internal combustion engine according to claim 1, wherein, along a surface of the second inclined surface, an imaginary line extending from the second inclined surface toward the inner side in the radial direction passes between an apex of the raised portion and the injector.

7. The internal combustion engine according to claim 1, wherein the second inclined surface and the step portion are provided along the circumferential direction.

8. The internal combustion engine according to claim 1, wherein a plurality of second inclined surfaces and a plurality of step portions are provided at predetermined intervals in the circumferential direction.

9. The internal combustion engine according to claim 3, wherein the step surface is a flat surface perpendicular to the second inclined surface.
